(19) United States
(12) Patent Application Publication
(10) Pub. No.: US 2009/0181293 A1
(43) Pub. Date: Jul. 16, 2009

(54) AA ALKALINE BATTERY

(76) Inventors: Fumio Kato, Osaka (JP); Hidekatsu Izumi, Osaka (JP)

Correspondence Address: MCDERMOTT WILL & EMERY LLP, 600 13TH STREET, NW, WASHINGTON, DC, 20005-3096, US

(21) Appl. No.: 12/334,105

(22) Filed: Dec. 12, 2008

Related U.S. Application Data
(60) Provisional application No. 61/022,670, filed on Jan. 22, 2008.

(30) Foreign Application Priority Data
Jan. 11, 2008 (JP) 2008-004679

(51) Int. Cl. H01M 10/24; H01M 2/14

(52) U.S. Cl. 429/129

(57) ABSTRACT

An AA alkaline battery includes: a positive electrode; a negative electrode; a separator; and an alkaline electrolyte. The negative electrode contains 4.0 g or more of zinc as an active material and an indium compound in the range from 50 ppm to 1000 ppm, both inclusive, with respect to the weight of zinc. Zinc contained in the negative electrode includes zinc particles which has a size of 200 meshes or less and is in the range from 20 wt. % to 50 wt. %, both inclusive, with respect to the weight of zinc contained in the negative electrode.

### BACKGROUND OF THE INVENTION

(1) Field of the Invention

The present invention relates to AA alkaline batteries.

(2) Disclosure of Related Art

In alkaline batteries, there is the possibility of generation of hydrogen gas for the structural reasons. The generation of hydrogen gas increases the internal pressure, thus causing a hazard. In view of this, alkaline batteries are designed to prevent generation of hydrogen gas or to ensure the safety of the batteries even with generation of hydrogen gas.

Specifically, an alkaline battery uses zinc as a negative electrode active material and also uses a strong alkaline solution as an electrolyte which is in contact with a negative electrode. Accordingly, the surface of zinc might be corroded by the alkaline electrolyte so that hydrogen gas is generated. Since the alkaline battery is hermetically sealed, generation of hydrogen gas in the alkaline battery increases the pressure inside the alkaline battery to cause a hazard to the alkaline battery. To prevent this, mercury was added to negative electrodes in previous alkaline batteries to suppress generation of hydrogen gas. However, in consideration of environmental destruction caused by mercury, materials such as indium are now used in place of mercury in order to suppress generation of hydrogen gas (see Japanese Laid-Open Patent Publication No. 48-87342). In addition, Japanese Laid-Open Patent Publication No. 2-267856 discloses that corrosion of a negative electrode by an alkaline electrolyte is suppressed by using an indium compound and a fluorine-based surfactant.

In recent years, increase in capacity and power and cost reduction have been required of AA alkaline batteries. The increase in capacity of an AA alkaline battery is achieved by increasing the loading weight of an active material in the AA alkaline battery. However, in the AA alkaline battery, a positive electrode is formed in the form of a cylinder and a negative electrode is formed in the shape of a column and is housed inside the cylindrical positive electrode with a separator sandwiched therebetween. Accordingly, in high-rate discharge, only zinc around the separator contributes to battery reaction. Therefore, in this AA alkaline battery, it is difficult to increase the surface area of the negative electrode even by increasing the loading weight of the negative electrode. In other words, it is difficult to increase power of the AA alkaline battery only by increasing the loading weight of the negative electrode.

In view of this, Japanese Patent Application Publication No. 2001-512284 discloses that zinc particles are used as a negative electrode active material so that the surface area of the negative electrode active material is increased to enhance pulse characteristics of an alkaline battery.

### SUMMARY OF THE INVENTION

However, it was found that when an AA alkaline battery is fabricated by using zinc particles as a negative electrode active material, the voltage decreases at the end of discharge in which the AA alkaline battery is continuously discharged with heavy load.

It is therefore an object of the present invention to suppress a voltage drop in the end of continuous heavy-load discharge of a high-capacity and high-power AA alkaline battery.

Specifically, an AA alkaline battery according to the present invention includes: a positive electrode; a negative electrode; a separator; and an alkaline electrolyte. The negative electrode contains 4.0 g or more of zinc and an indium compound in the range from 50 ppm to 1000 ppm, both inclusive, with respect to the weight of zinc. Zinc contained in the negative electrode includes zinc particles having a size of 200 meshes or less in the range from 20 wt. % to 50 wt. %, both inclusive, with respect to the weight of zinc contained in the negative electrode.

In this configuration, the weight of zinc is greater than that in a conventional AA alkaline battery, thus allowing an increase in capacity of the AA alkaline battery.

In addition, in the above configuration, the surface area of the negative electrode is increased, thus allowing an increase in power of the AA alkaline battery. In other words, the surface area of the negative electrode is increased, thus achieving better discharge characteristics in intermittently discharging the AA alkaline battery with heavy load (i.e., pulse characteristics in heavy-load discharge).

Furthermore, in the above structure, the indium compound serves as indium metal and electrically bonds zinc particles to one another in the negative electrode, thus strengthening electrical connection among zinc particles in a conductive network (formed by electrically connecting zinc particles) in the negative electrode. Accordingly, it is possible to suppress a voltage drop at the end of discharge in which heavy-load discharge is continuously performed.

In the AA alkaline battery of the present invention, the alkaline electrolyte preferably contains a phosphoric acid-based surfactant in the range from 300 ppm to 3000 ppm, both inclusive, with respect to the weight of zinc contained in the negative electrode, and the phosphoric acid-based surfactant preferably has an average molecular weight of 100 to 500, both inclusive. With this configuration, generation of hydrogen gas is suppressed, thus suppressing leakage of the alkaline electrolyte.

### BRIEF DESCRIPTION OF THE DRAWINGS

FIG. 1 is a half sectional view illustrating a structure of an AA alkaline battery according to an embodiment of the present invention.

FIG. 2 is a graph showing discharge curves obtained by continuously discharging AA alkaline batteries of Example and Comparative Example, respectively, to 0.7 V at 1 W in an atmosphere of 20° C.

### DETAILED DESCRIPTION OF THE INVENTION

Prior to description of an embodiment of the present invention, circumstances that led to the present invention are explained.

As described above, increase in capacity and power has been recently required of AA alkaline batteries. In view of this, as disclosed in, for example, Japanese Patent Application Publication No. 2001-512284, the inventors of the present invention fabricated an AA alkaline battery using zinc particles with a small grain diameter as a negative electrode active material and continuously discharged the AA alkaline battery with heavy load to examine voltage characteristics thereof. In this examination, a voltage drop was observed at the end of the discharge. The inventors thought this result was due to the following reason:

A gelled negative electrode used for an alkaline battery is obtained by suspending and dispersing zinc particles in an electrolyte which is gelled with a thickener such as polyacrylic acid. Zinc particles (bulk) themselves are conductors. Accordingly, the gelled negative electrode does not function as a negative electrode by adding a conductivity assistant, but a kind of conductive network formed by partial contact among zinc particles in an electrolyte functions as a negative electrode.

In a gelled negative electrode containing a large amount of zinc particles with a small grain diameter, these zinc particles are in contact with the electrolyte in a large area (total surface area). Thus, this structure is advantageous for heavy-load pulse discharge (i.e., for intermittently performing discharge with heavy load) in which momentary reactivity and reaction amount of the whole zinc particles greatly affect discharge characteristics. In such a gelled negative electrode, however, zinc particles are not in contact with each other so that only weak electrical connection is established among zinc particles in a conductive network. Accordingly, when an AA alkaline battery is fabricated using a gelled negative electrode and is continuously discharged with heavy load, accumulated ZnO (where ZnO is a product of reaction and is a nonconductor) might break the conductive network of the negative electrode, causing a voltage drop at the end of this discharge. To prevent this, the inventors contrived the structure of a negative electrode to prevent a conductive network of the negative electrode from being broken even at the end of discharge in which heavy-load discharge is continuously performed with a large area (total surface area) of zinc particles in contact with an electrolyte maintained, thus completing the present invention. Hereinafter, an embodiment of the present invention will be described with reference to the drawings.

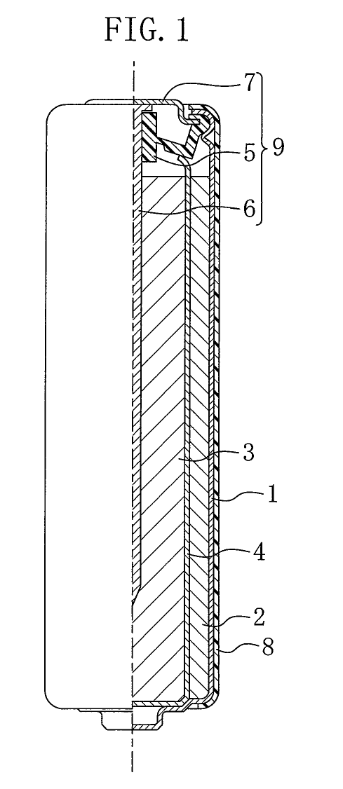

FIG. 1 is a cross-sectional view illustrating a structure of a general alkaline battery as an embodiment of the present invention.

As illustrated in FIG. 1, the alkaline battery includes a cylindrical battery case 1 which is sealed at one end (i.e., at the lower end in FIG. 1). The outer surface of the battery case 1 is covered with an exterior label 8. The battery case 1 serves as a positive electrode terminal and a positive electrode current collector. A hollow cylindrical positive electrode 2 is inscribed in the battery case 1. A separator 4 is provided in the hollow portion of the positive electrode 2 and formed in the shape of a cylinder which is sealed at one end. A negative electrode 3 is placed in the hollow portion of the separator 4. Accordingly, the battery case 1 is configured such that the positive electrode 2, the separator 4, and the negative electrode 3 are arranged in this order in the direction from the periphery to the center thereof.

The opening (i.e., the upper end in FIG. 1) of the battery case 1 is sealed by an assembled sealing unit 9. The assembled sealing unit 9 is configured by integrating a nail-shaped negative electrode current collector 6, a negative electrode terminal plate 7, and a resin gasket 5. The negative electrode terminal plate 7 is electrically connected to the negative electrode current collector 6. The resin gasket 5 is fixed to the negative electrode current collector 6 and the negative electrode terminal plate 7. In fabricating an alkaline battery, power generation elements such as the positive electrode 2 and the negative electrode 3 are housed in the battery case 1, and then the opening of the battery case 1 is sealed by the assembled sealing unit 9.

The positive electrode 2, the negative electrode 3, and the separator 4 contain an alkaline electrolyte (not shown). As the alkaline electrolyte, an aqueous solution containing 30 to 40 wt. % of potassium hydroxide and 1 to 3 wt. % of zinc oxide is used.

Now, compositions, for example, of the positive electrode 2, the negative electrode 3, the separator 4, the battery case 1, the resin gasket 5, the negative electrode current collector 6, and the negative electrode terminal plate 7 are sequentially described.

The positive electrode 2 contains a mixture of a positive electrode active material such as electrolytic manganese dioxide powder, a conductive agent such as graphite powder, and an alkaline electrolyte. A binder such as polyethylene powder or a lubricant such as stearate may be added to the positive electrode 2 as necessary.

The negative electrode 3 is obtained by, for example, adding a gelling agent such as polyacrylic acid to an alkaline electrolyte and dispersing zinc particles (i.e., a negative electrode active material) in the resultant gelled alkaline electrolyte.

As the negative electrode active material, a zinc alloy having high corrosion resistance is preferably used, and a zinc alloy free from mercury, cadmium, and lead is more preferably used in consideration of the environment. Examples of the zinc alloy include a zinc alloy containing at least one of indium, aluminum, and bismuth. To suppress zinc dendrite formation, a trace amount of a silicon compound such as silicic acid or silicate may be added to the negative electrode 3 as necessary. The negative electrode 3 is specifically described below.

As the separator 4, nonwoven fabric obtained by mixing mainly polyvinyl alcohol fiber and rayon fiber is used, for example. The separator 4 is obtained with a known method disclosed in, for example, Japanese Laid-Open Patent Publications Nos. 6-163024 and 2006-32320.

The battery case 1 is obtained by, for example, press-molding a nickel-coated steel plate into a predetermined shape having predetermined dimensions with a known method disclosed in, for example, Japanese Laid-Open Patent Publications Nos. 60-180058 and 11-144690.

A through hole (not shown) into which the negative electrode current collector 6 is press fitted is formed in the center of the resin gasket 5. An annular thinner portion (not shown) functioning as a safety valve is provided around the through hole. An outer circumferential end portion (not shown) is continuously formed along the periphery of the annular thinner portion. The resin gasket 5 is obtained by, for example, injection-molding a material such as nylon or polypropylene into a predetermined shape having predetermined dimensions.

The negative electrode current collector 6 is obtained by press-molding a wire material of, for example, silver, copper, or brass into a nail shape having predetermined dimensions. To prevent mixture of an impurity during the molding and conceal an impurity, the surface of the negative electrode current collector 6 is preferably plated with, for example, tin or indium.

The negative electrode terminal plate 7 includes a terminal portion (not shown) for sealing the opening of the battery case 1 and a circumferential flange portion which extends from the terminal portion (not shown) and is in contact with the resin gasket 5. The circumferential flange portion has a plurality of gas holes (not shown) for releasing pressure when the safety valve of the resin gasket 5 is actuated. The negative electrode terminal plate 7 is obtained by, for example, press-molding a nickel-coated or tin-coated steel plate into a predetermined shape having predetermined dimensions.

Now, the negative electrode 3 of this embodiment is described in comparison with a negative electrode in a conventional AA alkaline battery.

The negative electrode 3 of this embodiment contains zinc as an active material, as a negative electrode of a conventional AA alkaline battery, but the amount of zinc contained in the negative electrode 3 of this embodiment is larger than that in the conventional AA alkaline battery. Specifically, the AA alkaline battery of this embodiment contains 4.0 g or more of zinc, whereas the conventional AA alkaline battery contains about 3.8 g of zinc. That is, the AA alkaline battery of this embodiment contains a larger amount of zinc than the conventional AA alkaline battery. As a result, the capacity is increased.

The negative electrode 3 includes zinc particles having a small grain diameter (specifically, 200 meshes or less). In such a manner, when zinc particles having a small grain diameter are included, the surface area of the negative electrode 3 is larger than that in the case where no zinc particles having a small grain diameter are included. Consequently, pulse characteristics in heavy-load discharge of the AA alkaline battery are enhanced.

To enhance pulse characteristics (i.e., to increase the power) of an AA alkaline battery in heavy-load discharge, the content of zinc particles having a small grain diameter is preferably high. However, when the content is excessively high, it is difficult to fill the battery case 1 with the negative electrode 3 in fabrication. To ease fabrication of an AA alkaline battery and enhance pulse characteristics of the AA alkaline battery in heavy-load discharge, the content of zinc particles having a small grain diameter is preferably in the range from 20 wt. % to 50 wt. %, both inclusive, with respect to the total weight of zinc.

As described above, the use of zinc particles having a small grain diameter as a negative electrode active material weakens electrical connection among zinc particles in a conductive network of the negative electrode 3, thus causing a voltage drop at the end of discharge in which heavy-load discharge is continuously performed. On the other hand, in this embodiment, an indium compound (e.g., indium oxide or indium hydroxide) is added to the negative electrode 3 in addition to zinc particles so that strong electrical connection among zinc particles in the conductive network of the negative electrode 3 is maintained even at the end of discharge. Specifically, when an indium compound is added to the negative electrode 3 in addition to zinc particles, it is possible to suppress destruction of the conductive network of the negative electrode 3 by ZiO at the end of discharge in which heavy-load discharge is continuously performed. Hereinafter, a specific example is shown.

An alkaline electrolyte is held in the negative electrode 3. Since the alkaline electrolyte is a strong alkaline solution, an indium compound added to the negative electrode 3 is dissolved in the alkaline electrolyte in the form of ions. Since indium exists as a metal (i.e., solid) at the equilibrium potential of zinc, the dissolved indium ions are precipitated again as a metal on the surface of zinc particles. In the negative electrode 3, zinc particles are in close proximity to one another. Accordingly, indium is precipitated again on the surface of zinc particles to bond the zinc particles. This strengthens electrical connection among zinc particles in the conductive network of the negative electrode 3, thus suppressing destruction of the conductive network of the negative electrode 3 at the end of discharge in which heavy-load discharge is continuously performed.

As described above, as a metal compound to be added to the negative electrode 3 in order to strengthen electrical connection among zinc particles in the conductive network of the negative electrode 3, any compound that is soluble in an alkaline solution as ions and contains a metal capable of being precipitated as a metal at the equilibrium potential of zinc may be used. The examination of the inventors showed that a metal compound satisfying the above two requirements was an indium compound. Thus, an indium compound is preferably added to the negative electrode 3.

Increase in content of an indium compound strengthens bonding of zinc particles so that the zinc particles in the conductive network of the negative electrode 3 are more strongly electrically connected to one another. However, an excessively high content of an indium compound reduces the content of zinc in the negative electrode 3, thus making it difficult to increase the capacity of the AA alkaline battery. In addition, using an excessively high content of an indium compound is unpreferable because indium is expensive and thus the cost for the AA alkaline battery increases. To achieve both capacity increase and cost reduction for the AA alkaline battery without weakening electrical connection among zinc particles in the conductive network of the negative electrode 3, the content of an indium compound is preferably in the range from 50 ppm to 1000 ppm, both inclusive, with respect to the weight of zinc, and is more preferably in the range from 100 ppm to 600 ppm, both inclusive.

In this manner, electrical connection among zinc particles in the conductive network of the negative electrode 3 of this embodiment is stronger than that in a negative electrode containing no indium compound, resulting in suppressing drawbacks such as a voltage drop at the end of discharge in which the AA alkaline battery is continuously discharged with heavy load.

In addition, precipitation of indium on the surface of zinc particles suppresses zinc corrosion caused by an alkaline electrolyte, thus suppressing generation of hydrogen gas. As a result, increase in internal pressure of the AA alkaline battery is suppressed, thus suppressing leakage of the alkaline electrolyte when a safety valve opens.

Addition of an indium compound to the negative electrode 3 is enough to suppress leakage of the alkaline electrolyte. However, it is more preferable to mix a phosphoric acid-based surfactant in the alkaline electrolyte. As long as an indium compound is added to the negative electrode 3 and a phosphoric acid-based surfactant is contained in the alkaline electrolyte, even if an impurity such as iron is mixed in the negative electrode 3, leakage of the alkaline electrolyte resulting from this mixture is suppressed. The inventors believe that this is because of the following reasons:

In a strong alkaline electrolyte such as a negative electrode of an alkaline battery, OH⁻ is trapped at the metal surface so that the surface of zinc is negatively charged. Since a hydrophilic portion of a phosphoric acid-based surfactant is negatively charged, electrostatic repulsion occurs between zinc and the hydrophilic portion of the phosphoric acid-based surfactant. However, since the degree of solubility of the phosphoric acid-based surfactant in the strong alkaline electrolyte is greatly lower than that of a phosphoric acid-based surfactant in a neutral aqueous solution, part of the phosphoric acid-based surfactant insoluble in the strong alkaline electrolyte is expelled from the strong alkaline electrolyte and comes to be arranged at the interface between the strong alkaline electrolyte and zinc (metal). Under an alkaline state, indium is more highly negatively charged than zinc and iron so that a relatively large amount of the surfactant is considered to be collected at the surface of indium. In other words, in an alkaline state, the largest amount of coating of the surfactant is formed on the surface of indium. In consideration of level of the equilibrium potential, indium is considered to be more likely to be precipitated on the surface of iron than on the surface of zinc. Accordingly, indium is precipitated on the surface of iron. In this manner, coating of the surfactant is formed on the surface of indium precipitated on the surface of iron. Accordingly, the precipitated indium and the coating of the surfactant are formed in this order on the surface of iron. This structure prevents water molecules from approaching the surface of iron, thus suppressing generation of hydrogen gas resulting from mixture of iron. Accordingly leakage of the alkaline electrolyte is suppressed.

Such a phosphoric acid-based surfactant preferably has an average molecular weight of 100 to 500, both inclusive. The content of the phosphoric acid-based surfactant is preferably in the range from 300 ppm to 3000 ppm, both inclusive, with respect to the weight of zinc. The phosphoric acid-based surfactant may be bivalent anion such as ROPO₃Na₂ or ROPO₃K₂ or monovalent anion such as (RO)₂PO₂Na or (RO)₂PO₂K. In those chemical formulas, R is an alkyl group. As a counter cation of the phosphoric acid-based surfactant, any of H, K, and Na may be used. The phosphoric acid-based surfactant may have a structure partially including an ethylene oxide structure (e.g., (CH₂CH₂O)ₙ), such as R(CH₂CH₂O)ₙPO₃Na₂.

The technique for allowing an indium compound and a surfactant to coexist in an alkaline electrolyte is already known (e.g., Japanese Laid-Open Patent Publication No. 2-267856). However, in this embodiment, a large amount of a phosphoric acid-based surfactant having a lower molecular weight than that in a known alkaline battery is used. This effectively suppresses leakage of an alkaline electrolyte resulting from mixture of an impurity (iron) without a voltage drop in heavy-load pulse discharge. The inventors believe that addition of a low-molecular-weight phosphoric acid-based surfactant to an alkaline electrolyte suppresses a voltage drop observed in a heavy-load pulse discharge because of the following reason: With a surfactant having a low molecular weight, a change in electric field near the zinc surface at discharge instantly breaks arrangement in the surfactant so that the surfactant does not inhibit supply of OH⁻ ions to zinc, which is necessary for discharge reaction, or diffusion of zinc acid ions.

As described above, the AA alkaline battery of this embodiment achieves larger capacity and better pulse characteristics in heavy-load discharge than a conventional AA alkaline battery. In addition, in the AA alkaline battery of this embodiment, electrical connection among zinc particles in the conductive network of the negative electrode 3 is strengthened, thus suppressing a voltage drop at the end of discharge in which heavy-load discharge is continuously performed. Furthermore, indium is provided on the surface of zinc particles in the negative electrode 3 so that corrosion of zinc by the alkaline electrolyte is suppressed, resulting in suppressing leakage of the alkaline electrolyte.

Though not specifically described, since the amount of the negative electrode active material in this embodiment is larger than that in a negative electrode active material of a conventional AA alkaline battery, the amount of a positive electrode active material is preferably increased accordingly.

### EXAMPLE

An example of the present invention is now described. In Example below, an AA alkaline battery was fabricated in the following manner, and then discharge characteristics of the alkaline battery were evaluated and gas generation rate was measured.

### (AA Alkaline Battery According to Example)

First, zinc alloy particles containing 0.005 wt. % of Al, 0.005 wt. % of Bi, and 0.020 wt. % of In with respect to the weight of zinc were prepared by a gas atomizing method. Then, these zinc alloy particles were classified with a screen. With this classification, a negative electrode active material which had a grain size of 70 to 300 meshes and in which the ratio of zinc alloy particles having a grain diameter of 200 meshes (i.e., 75 μm) or less was 30% was obtained.

Next, polyacrylic acid and sodium polyacrylate were added to and mixed with 100 weight parts of 34.5 wt. % of a potassium hydroxide aqueous solution (containing 2 wt. % of ZnO) in such a manner that the total weight was 2.2 weight parts, and the resultant mixture was made into gel, thereby obtaining a gelled electrolyte. Thereafter, this gelled electrolyte was left alone for 24 hours to be sufficiently matured.

Then, the zinc alloy particles in an amount 2.00 times as much as a given amount of the gelled electrolyte in weight ratio, 0.05 weight part of indium hydroxide (powder having an average particle diameter (D50) of 1.8 μm and produced by KONAN MUKI CO., LTD: 0.033 weight part as metal indium) with respect to 100 weight parts of the zinc alloy particles, and 0.1 weight part of a phosphoric acid-based surfactant (e.g., alcohol sodium phosphate ester having an average molecular weight of about 210) were added to and were sufficiently mixed with the gelled electrolyte, thereby obtaining a gelled negative electrode.

Thereafter, electrolytic manganese dioxide (HHTF: a product by TOSOH CORPORATION) and graphite (SP-20: a product by Nippon Graphite Industries, ltd.) were blended at a weight ratio of 94:6, thereby obtaining mixed powder. With 100 weight parts of this mixed powder, 1.5 weight parts of an electrolyte (e.g., 39 wt. % of a potassium hydroxide aqueous solution containing 2 wt. % of ZnO) and 0.2 weight part of a polyethylene binder were mixed. Then, the mixture was uniformly stirred and mixed by a mixer, and was sized to have a given grain size. The obtained grain substance was press formed into a hollowed cylindrical shape. In this manner, a positive electrode mixture in the form of a pellet was obtained.

Subsequently, a sample AA alkaline battery was prepared. Specifically, as illustrated in FIG. 1, two pellets of a positive electrode mixture (weight: 5.15 g per one pellet) were inserted into the battery case 1, and pressure was applied again thereto in the battery case 1, thereby bringing the pellets into close contact with the inner face of the battery case 1. Then, a separator 4 and a bottom insulator for insulating the bottom of the battery case 1 were placed inside the positive electrode mixture pellets. Thereafter, 1.5 g of an electrolyte (e.g., 34.5 wt. % of a potassium hydroxide aqueous solution containing 2 wt. % of ZnO) was injected. After the injection, the inside of the separator 4 was filled with 6.2 g of a gelled negative electrode 3 (containing 4.1 g of zinc alloy particles). Subsequently, the opening of the battery case 1 was sealed by an assembled sealing unit 9 formed by integrating a resin gasket 5, a negative electrode current collector 6, and a negative electrode terminal plate 7. Specifically, the negative electrode current collector 6 was inserted in the negative electrode 3, and the circumferential flange portion of the negative electrode terminal plate 7 was crimped to the rim of the opening of the battery case 1 with the outer circumferential end portion of the resin gasket 5 interposed therebetween, thereby bringing the negative electrode terminal plate 7 into close contact with the opening of the battery case 1. Then, the outer surface of the battery case 1 was covered with an exterior label 8, thus completing an AA alkaline battery according to Example.

As a material of the resin gasket 5, nylon 6,6 was used. As the negative electrode current collector 6, a brass wire plated with Sn was used. As the separator 4, an alkaline battery separator (i.e., a composite fiber made of vinylon and tencel®) produced by KURARAY CO., LTD was used.

### (Method for Fabricating AA Alkaline Battery According to Comparative Example)

An AA alkaline battery according to Comparative Example was fabricated in the same manner as a method for fabricating an AA alkaline battery of Example, except that no indium hydroxide was added in the formation of a negative electrode. As in an AA alkaline battery of Example, discharge characteristics of the AA alkaline battery of Comparative Example were evaluated.

### (Method for Evaluating Discharge Characteristics)

Discharge characteristics of batteries of Example and Comparative Example were evaluated in the following manner:
(1) Discharge characteristics in heavy-load pulse discharge (in which heavy-load discharge is intermittently performed)

Pulse discharge in which a process of discharging one battery cell at 1.5 W for two seconds and then discharging the cell at 0.65 W for 28 seconds was repeated in an atmosphere of 20° C. was performed 10 cycles per one hour. Then, the number of pulses until the closed circuit voltage reached 1.05 V was counted. The discharge test prescribed in ANSI C18.1M was applied mutatis mutandis to this evaluation.
(2) Discharge characteristics in heavy-load continuous discharge (in which heavy-load discharge is continuously performed)

One battery cell was continuously discharged to 0.7 V at 1 W in an atmosphere of 20° C. In consideration of an actual operation voltage of equipment, the time necessary for the closed circuit voltage to reach 0.9 V (end voltage) from the start of discharge was obtained as a discharge duration. In the same manner, discharge durations before the closed circuit reached 0.9 V were obtained for the case of continuous discharge performed at 1.2 W in an atmosphere of 20° C. and the case of continuous discharge performed at 1 W in an atmosphere of 0° C. (low temperature).

Table 1 shows the obtained results on discharge characteristics. Discharge characteristics of three new batteries were also evaluated. The average value thereof is also shown in Table 1. Parenthesized values in Table 1 are expressed as indexes when the values of Comparative Example are 100.

TABLE 1

| | | Discharge method | | | |
|---|---|---|---|---|---|
| | | (1) Heavy-load pulse | (2) Heavy-load continuous | | |
| | | discharge | discharge | | |
| | | Discharge conditions | | | |
| | | 1.5 W/0.65 W | 20° C., 1 W | 20° C., 1.2 W | 0° C., 1 W |
| | | Measured physical amount | | | |
| | | The number of pulses | Discharge duration [min.] | | |
| Example | — | 119 (100) | 66.1 (104) | 50.0 (105) | 30.3 (105) |
| Comparative | — | 119 (100) | 63.4 (100) | 47.8 (100) | 28.8 (100) |
| Example | | | | | |

For discharge characteristics in (1) heavy-load pulse discharge, there was not much difference between Example and Comparative Example. Here, it should be noted that for most of the currently-available alkaline batteries, the number of pulses is less then 110 cycles when heavy-load discharge is intermittently performed and the obtained number of pulses, i.e., 119 cycles, is an extremely large value. The reason for obtaining such excellent characteristics are considered to be due to: the fact that the loading weight of zinc was much higher than that in a conventional AA alkaline battery (in which the loading weight of zinc is 4.10 g); and the fact that zinc particles were made small such that the ratio of zinc alloy particles having a grain diameter of 200 meshes (75 μm) or less was 30%, for example.

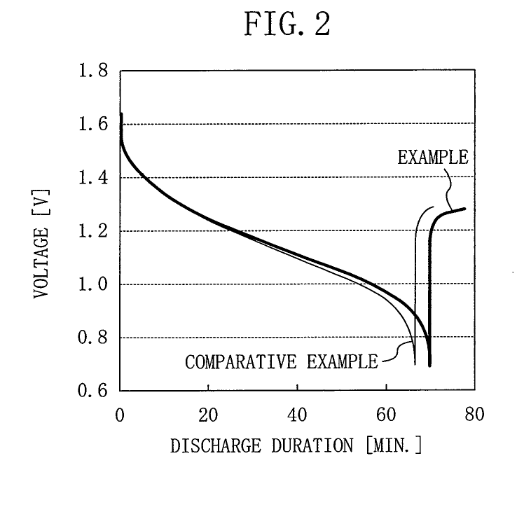

On the other hand, for discharge characteristics in (2) heavy-load continuous discharge, there was a characteristic difference of 4 to 5% between Example and Comparative Example. FIG. 2 shows an exemplary discharge curve of continuous discharge performed at 1 W in an atmosphere of 20° C. As shown in FIG. 2, the batteries of Example and Comparative Example exhibited the same voltage behavior (in FIG. 2, two curves coincide with each other) at the initial stage of discharge. However, in a period from around the middle to the end of discharge, the voltage of the battery of Comparative Example greatly decreased (i.e., polarization occurs) so that the difference in discharge characteristics appeared between the battery of Example and the battery of Comparative Example.

In this manner, the battery of Comparative Example exhibited excellent discharge characteristics to substantially the same level as the battery of Example in the case where heavy-load discharge was intermittently performed. On the other hand, discharge characteristics in the case where heavy-load discharge was continuously performed, the voltage decreased at the end of the discharge. Such a behavior of the battery of Comparative Example suggests the following phenomenon:

When a high content of zinc particles having a small grain diameter are contained in a negative electrode, the area (total surface area) where the zinc particles are in contact with an electrolyte increases. Therefore, this structure is advantageous for the case of (1) heavy-load pulse discharge in which momentary reactivity and reaction amount of the whole zinc particles greatly affect discharge characteristics.

However, in such a negative electrode, zinc particles are not in contact with one other so that electrical connection among zinc particles in a conductive network of the negative electrode is weak. Accordingly, in (2) continuous heavy-load continuous discharge, ZnO as a product of reaction starts being accumulated from around the middle of the continuous discharge so that the accumulated ZnO breaks the conductive network of the negative electrode. Consequently, a voltage drop occurs in a period from around the middle to the end of the discharge.

On the other hand, in the battery of Example, it is believed that metal indium bonds zinc particles while indium hydroxide added to the negative electrode is dissolved in the alkaline electrolyte and is precipitated again on zinc, thus strengthening electrical connection among zinc particles in the conductive network of the negative electrode. Accordingly, it is estimated that destruction of the conductive network of the negative electrode resulting from accumulation of ZnO as a reaction product was suppressed so that a high voltage was maintained even in a period from around the middle to the end of discharge.

### (Gas Generation Test for Examining Influence of Iron as Impurity)

Subsequently, a test was conducted to examine the effect, on hydrogen gas generation, of indium hydroxide and a phosphoric acid-based surfactant as additives.

First, zinc alloy particles, a gelled electrolyte, indium hydroxide, and a phosphoric acid-based surfactant used for fabricating a battery of Example were prepared, and were mixed at a weight ratio shown in Table 2 below, thereby fabricating gelled negative electrodes a through d.

TABLE 2

Gelled negative electrode

| | a | b | c | d |
|---|---|---|---|---|
| Zinc alloy particles | 100 | 100 | 100 | 100 |
| Gelled electrolyte | 50 | 50 | 50 | 50 |
| Indium hydroxide | 0.05 | 0.05 | — | — |
| Phosphoric acid-based | 0.1 | — | 0.1 | — |
| surfactant | | | | |

Next, as an impurity to the gelled negative electrodes a through d, only 10 ppm of iron powder (produced by KOJUNDO CHEMICAL LABORATORY CO., LTD) having a grain diameter of 3 μm to 5 μm with respect to the weight of a zinc alloy was added. In this manner, gelled negative electrodes containing iron as an impurity were prepared. Then, the rates of gas generation in the gelled negative electrodes containing iron as an impurity were obtained with a method described below. A method for obtaining the gas generation rate as used herein is disclosed in, for example, Japanese Laid-Open Patent Publications Nos. 57-048635 and 7-245103 and Japanese Laid-Open Patent Publication No. 2006-4900.

To obtain a gas generation rate, 5.00 g of a gelled negative electrode containing iron as an impurity was inserted in a glass jig for capturing gas. This glass jig was provided with a graduated tube and was constituted by a plug and a vessel. Subsequently, liquid paraffin was poured into the glass jig in such a manner that the gelled negative electrode was completely sunk in the liquid paraffin without air left therein. Thereafter, the glass jig was plugged and sealed. The sealed glass jig was immersed in a thermostat kept at 45° C. and was left for about three hours such that the temperature in the glass jig was kept at a constant temperature. In this state, the total amount of gas generation in three days was then measured, and the rate of gas generation was calculated according to the following equation:

Gas generation rate (μL/g·day)=the total amount of gas generation in three days (μL)÷5 (g)÷3 (day)

Table 3 shows the obtained results. The gas generation rates of five new batteries including gelled negative electrodes were obtained and the average value thereof is shown in Table 3.

TABLE 3

| | Type of iron-containing gelled negative electrode | | | |
|---|---|---|---|---|
| | a | b | c | d |
| Indium hydroxide | Contained | Contained | None | None |
| Surfactant | Contained | None | Contained | None |
| 45° C. gas | 9 | 77 | 140 | 170 |
| generation rate | | | | |
| [μL/g · day] | | | | |

As shown in Table 3, the gas generation rate of the gelled negative electrode d containing no additives (none of indium hydroxide and a phosphoric acid-based surfactant) was very high. This is considered to be because a very low hydrogen overvoltage at the iron surface causes hydrogen gas to be continuously generated at the iron surface charged to the potential of zinc.

In the gelled negative electrode c containing only a phosphoric acid-based surfactant as an additive, the phosphoric acid-based surfactant was arranged at the interface between a strong alkaline electrolyte and zinc so that a protection coating is formed on the surfaces of zinc and iron, resulting in a lower gas generation rate than that in the gelled negative electrode d. In the same manner, in the gelled negative electrode b containing only indium hydroxide as an additive, indium precipitated again on the zinc surface increases the hydrogen overvoltages of zinc and iron so that the gas generation rate was lower than that in the gelled negative electrode d. In this manner, the gas generation rates in the gelled negative electrodes b and c were lower than that in the gelled negative electrode d. However, these gas generation rates were not enough to prevent leakage. In general, leakage is considered to occur when the gas generation rate exceeds about 10 μL/g·day.

On the other hand, in the gelled negative electrode a containing both indium hydroxide and a phosphoric acid-based surfactant as additives, synergistic effects of the two additives greatly reduced the gas generation rate upon mixture of iron. The mechanism of suppressing hydrogen gas generation by the synergistic effects is already described in the above embodiment.

Specifically, the gelled negative electrode a is considered to be in a state in which indium was precipitated on the iron surface and a coating of the phosphoric acid-based surfactant was formed on the indium surface. When such a coating is formed on the iron surface, approach of water molecules to iron is inhibited. Thus, it can be concluded that the rate of hydrogen gas generation in the gelled negative electrode a was sufficiently low as shown in Table 3.

What is claimed is:

1. An AA alkaline battery, comprising:
a positive electrode;
a negative electrode;
a separator placed between the positive electrode and the negative electrode; and
an alkaline electrolyte,
wherein the negative electrode contains 4.0 g or more of zinc and an indium compound in the range from 50 ppm to 1000 ppm, both inclusive, with respect to the weight of zinc contained in the negative electrode, and
zinc contained in the negative electrode includes zinc particles having a size of 200 meshes or less in the range from 20 wt. % to 50 wt. %, both inclusive, with respect to the weight of zinc contained in the negative electrode.

2. The AA alkaline battery of claim 1, wherein the alkaline electrolyte contains a phosphoric acid-based surfactant in the range from 300 ppm to 3000 ppm, both inclusive, with respect to the weight of zinc contained in the negative electrode, and
the phosphoric acid-based surfactant has an average molecular weight of 100 to 500, both inclusive.
